(19) United States
(12) Patent Application Publication
(10) Pub. No.: US 2005/0279540 A1
(43) Pub. Date: Dec. 22, 2005

(54) Adjustable wheelchair

(76) Inventors: Donald W. Wisner, Grand Haven, MI (US); Joshua A. Bordewyk, Fruitport, MI (US); Erik J. Denslow, Spring Lake, MI (US); Dennis V. Rupar, Grand Haven, MI (US); John W. Walwood, Grand Haven, MI (US); Jonathan D. Emery, Grandville, MI (US)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 10/862,588

(22) Filed: Jun. 7, 2004

(51) Int. Cl. B60K 1/00

(52) U.S. Cl. 180/65.1

(57) ABSTRACT

A wheelchair seat is provided with a power adjustment assembly that allows the user to control the depth and angle of the wheelchair seat relative to the wheelchair base. The wheelchair includes a seat depth adjustment mechanism and a seat angle adjustment mechanism that provide adjustment of the forward and rearward horizontal position of the seat, and the vertical position of both the rear portion and the front portion of the seat. The wheelchair may additionally include a tilt assembly interposed between the seat and the wheelchair base to provide tilt for the entire adjustable seat assembly relative to the base. The tilt assembly is actuated by fixed and movable telescopic rails, and is connected to the seat by a pivot rod and a pivot linkage.

### BACKGROUND OF THE INVENTION

The present invention relates to wheelchairs and more particularly to a power-adjustable wheelchair.

Powered wheelchairs have greatly increased the mobility of wheelchair occupants. Today's powered wheelchairs can provide movement for users of a wide range of disabilities, in some cases with the touch of a single button. Wheelchair bases, which can be conventionally attached to a variety of different seat assemblies, can be provided with a number of different drive options and control options to accommodate a wide range of users and a wide range of settings.

As wheelchairs progress, however, occupants continually spend greater amounts of time in them, often fixed in a single position for extended periods. For this reason, it is known in the wheelchair industry to provide wheelchairs with a tilt assembly. The tilt assembly may be powered, and generally allows the seat assembly to pivot from an “in use” position where the seat is essentially horizontal to a “weight shifting” position where the seat is angled backwards approximately 55 degrees. The tilt dramatically shifts the weight of the user to prevent ulcers and “bed sores,” encourage blood drainage from lower extremities, and prevent other problems related to sitting in a single position for a long period.

Unfortunately, while these conventional tilt assemblies often provide much needed relief for wheelchair occupants, the occupant is precluded from carrying on normal day-to-day functions when the seat is in the “weight shifting” position.

Furthermore, even with the numerous seating options available, it is extremely difficult to provide wheelchair seat assemblies that can accommodate a broad range of unique disabilities and special needs. Additionally, each wheelchair user's needs may change over time, making wheelchairs that were once properly fitted become uncomfortable and less usable, sometimes forcing the purchase of a different seat assembly altogether.

### SUMMARY OF THE INVENTION

The above mentioned difficulties are overcome by the present invention, wherein a wheelchair seat is provided with a 6-way power adjustment assembly that allows a user to control the depth and angle of the wheelchair seat relative to the wheelchair base.

In one embodiment, the wheelchair includes a seat depth adjustment mechanism and a seat angle adjustment mechanism that provide adjustment of the forward and rearward horizontal position of the seat, and the vertical position of both the rear portion and the front portion of the seat. The adjustment mechanisms provide adjustment for the seat and back support independent of any armrests or foot rests.

In another embodiment, the wheelchair additionally includes a tilt assembly. The tilt assembly provides tilt for the entire adjustable seat assembly relative to the base.

In another embodiment, the tilt assembly is actuated by fixed and movable telescopic rails. The movable rails may be translated within the fixed rails by an actuator that includes battery-operated motors. The movable rails are pivotally attached to a first portion of the seat assembly. A pivot linkage is attached between a second portion of the seat assembly and the fixed rails. As the movable rails are translated, the seat assembly is driven forward such that it pivots about the pivotal attachment and the linkage.

As disclosed, the invention allows occupants to easily change position at any time. The changes may be dramatic to provide a complete weight shift, or they may be very minor to allow users to respond to any slight discomfort or change in surroundings.

These and other objects, advantages, and features of the invention will be more fully understood and appreciated by reference to the description of the current embodiments and the drawings.

### BRIEF DESCRIPTION OF THE DRAWINGS

FIG. 1 is a perspective view of the wheelchair.

FIG. 2 is a side view of the wheelchair.

FIG. 3 is an exploded view of the seat assembly.

FIG. 4 is a perspective view of the seat assembly and tilt assembly.

FIG. 5 is a perspective view of the seat adjustment assembly.

FIG. 6 is a top view of the seat adjustment assembly.

FIG. 7 is an exploded view of the seat adjustment assembly.

FIG. 8 is a perspective view of the seat assembly and tilt assembly in a tilted position.

FIG. 9 is a side view of the seat assembly and the tilt assembly in a tilted position.

FIG. 10 is a top view of the seat assembly and the tilt assembly in a tilted position.

FIG. 11 is a front view of the seat assembly and the tilt assembly in a tilted position.

FIG. 12 is perspective view of the seat adjustment assembly and an exploded view of the tilt assembly.

FIG. 13 is a perspective view of the seat assembly in accordance with an alternative embodiment.

FIG. 14 is a side view of the seat assembly in accordance with an alternative embodiment.

FIG. 15 is a perspective view of the seat adjustment assembly in accordance with an alternative embodiment.

### DETAILED DESCRIPTION OF THE PREFERRED EMBODIMENT

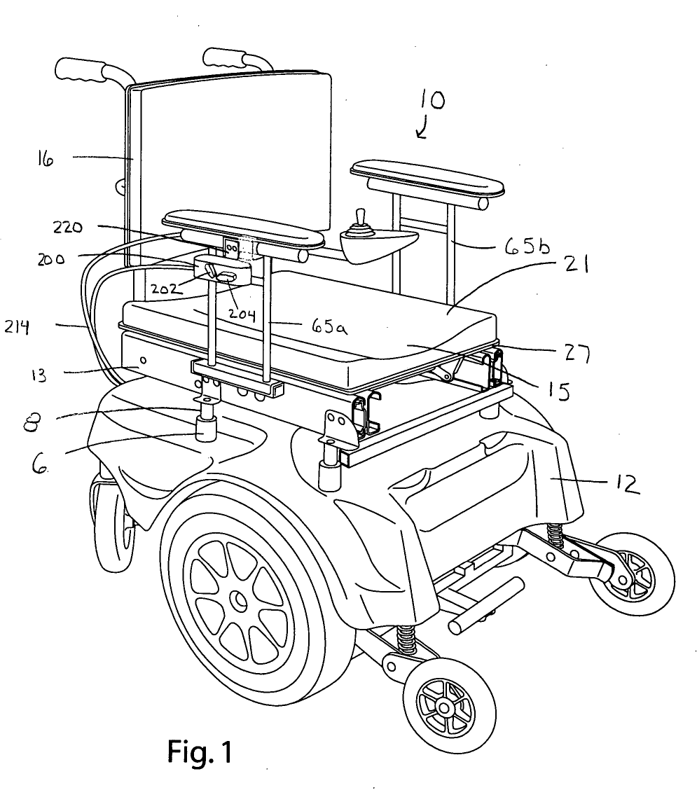

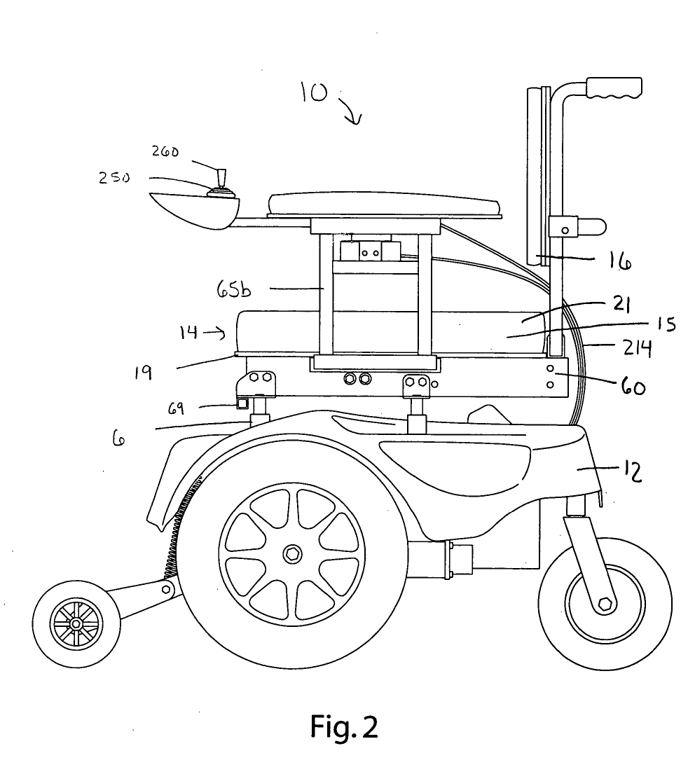

A wheelchair manufactured in accordance with one embodiment of the present invention is shown in FIG. 1, and generally designated 10. The wheelchair 10 generally includes a base 12 and a seat assembly 14. In one embodiment, the wheelchair 10 also includes a tilt assembly 13. The seat assembly 14 is generally conventional, including a generally conventional seat 15, a back support 16, and a seat adjustment assembly 17. The seat adjustment assembly 17 may include a seat angle adjustment mechanism 20 that permits adjustment of the angle of the seat 15 through independent control over the height of the front and the rear of the seat, and a seat depth adjustment mechanism 22 that permits forward and rearward adjustment of the seat 15. As shown in the embodiment of FIGS. 1 and 2, the seat assembly 14 is connected to the base 12 through the tilt assembly 13, and permits the seat assembly 14 to tilt with respect to the base 12. The tilt assembly 13, seat depth adjustment mechanism 22, and the seat angle adjustment mechanism 20, are each operated by battery powered electric motors. In this application, directional terms such as forward, rearward, inward and outward are used to denote directions relative to the geometric center of the appropriate component.

Shown in FIGS. 1 and 2, the wheelchair base 12 is preferably conventional, and therefore will not be described in great detail. In short, the base 12 of this embodiment includes at least a pair of wheels that are operated by a battery-powered motor. An upper portion of the base 12 is adapted to receive attachment mechanisms from the tilt assembly 13, for instance, by a plurality of tubular columns 6 that each receive a post 8 extending from the tilt assembly 13.

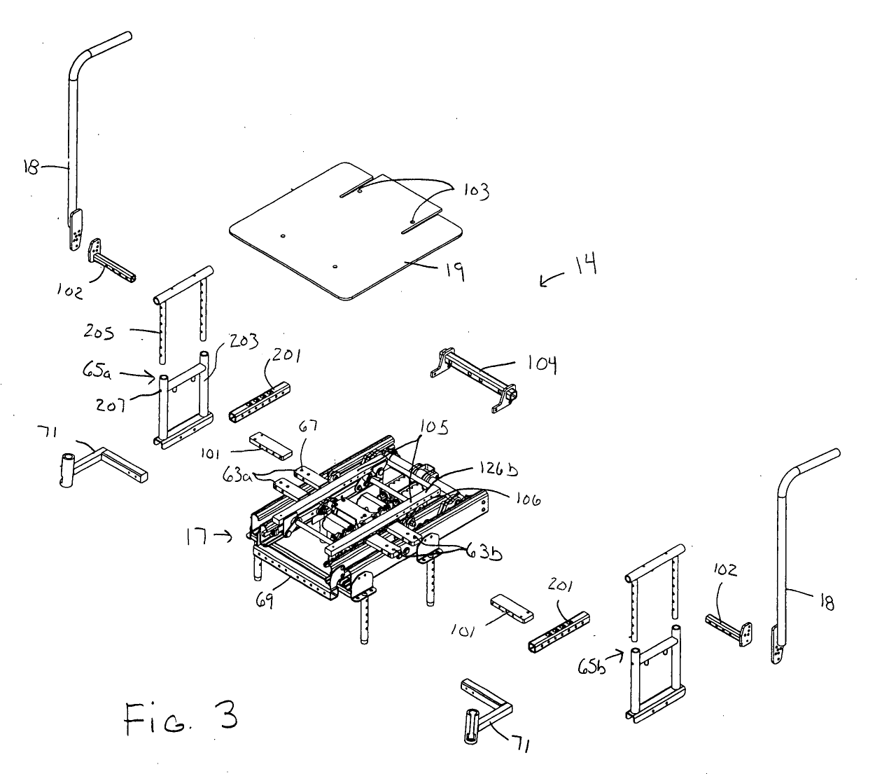

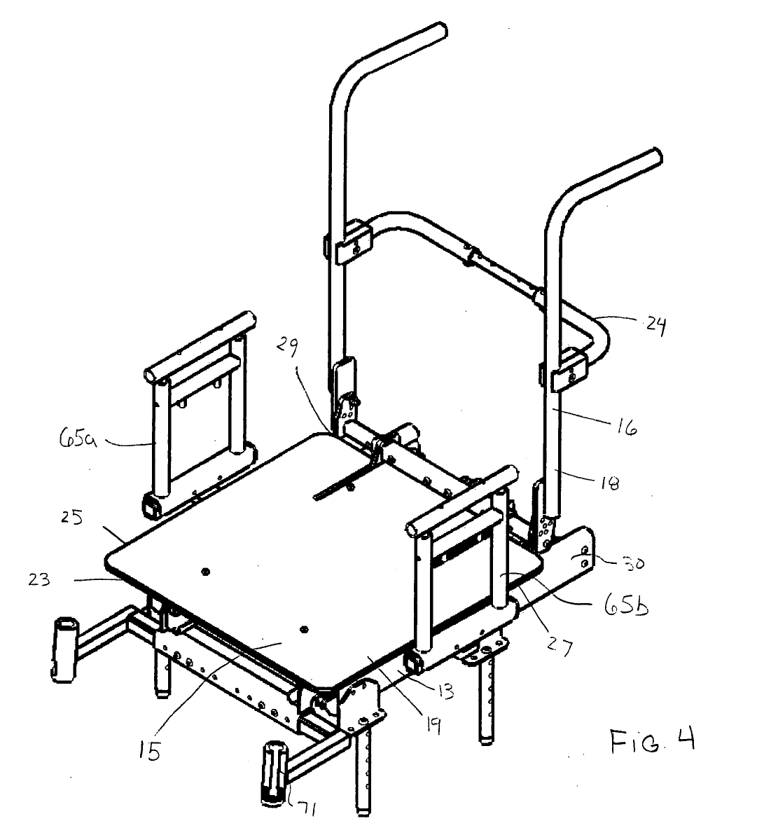

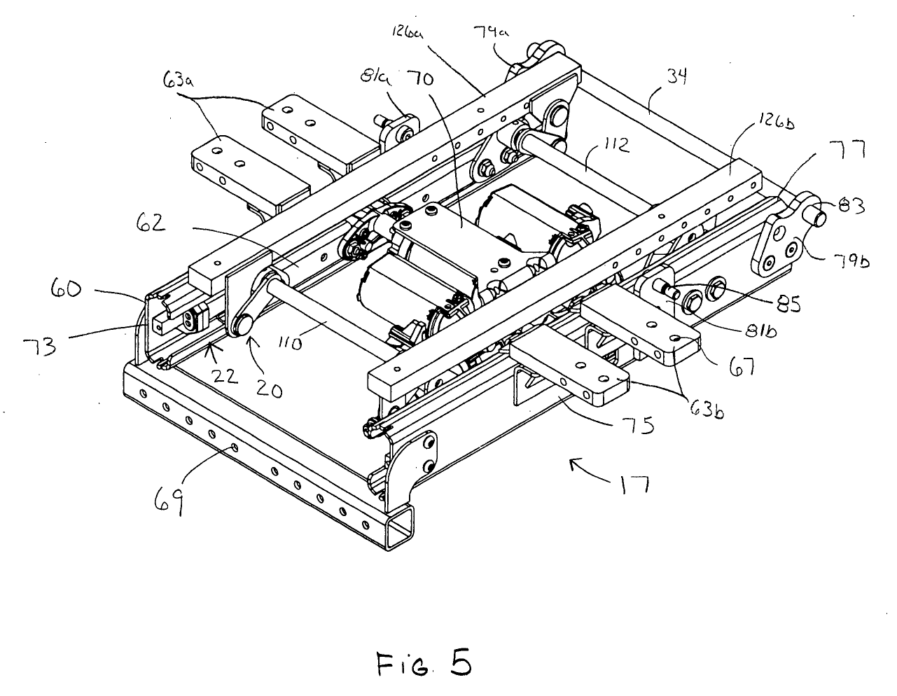

The seat assembly 14 includes a seat 15, a back support 16, and a seat adjustment assembly 17. The seat 15 includes one of a wide variety of conventional seat pans 19 and a similarly conventional cushion 21 on the seat pan 19. The seat pan 19 includes a front portion 23, right and left sides 25, 27 and a rear portion 29. The seat pan 19 conventionally attaches to the seat supports 126a-b (described below) with fasteners (not shown) extending through holes 103 in the seat pan 19 and corresponding holes 105 in the seat supports 126a-b. The back support 16 is also generally a standard part and, as shown in FIG. 3, is supported by upstanding handle members 18. The handle members attach to support posts 102, whereby the posts 102 extend into the left and right sides of the back support mounting bracket 104 and conventionally attach to the bracket 104. In one embodiment (not shown) the handle members 18 and therefore the back support 16 may articulate relative to the seat 15. A variety of methods for actuating this articulation are well known. The left to right location of the back support handles 18 may be adjustable, for instance, by the posts 102 being slidable in and out of the bracket 104. The bracket 104 may contain a plurality of spaced holes to pin the posts 102 in a desired location. The back support mounting bracket 104 is attached to the seat 15 through fastener holes 106 on the seat supports 126a-b. The fore/aft position of the back support mounting bracket 104 may be adjustable in a manner similar to the posts 102, wherein the bracket 104 is variably slidable into the seat supports 126a-b until it is attached by the desired hole 106. As shown in FIGS. 4, 5 and 7, the seat adjustment assembly 17 includes a seat depth adjustment mechanism 22 and a seat angle adjustment mechanism 20. As described in more detail below, the seat assembly 14 may be attached directly to the base 12, or may be attached to the tilt assembly 13, which is then attached to the base 12. The illustrated seat assembly 14 is merely exemplary and may vary in construction from application to application as desired.

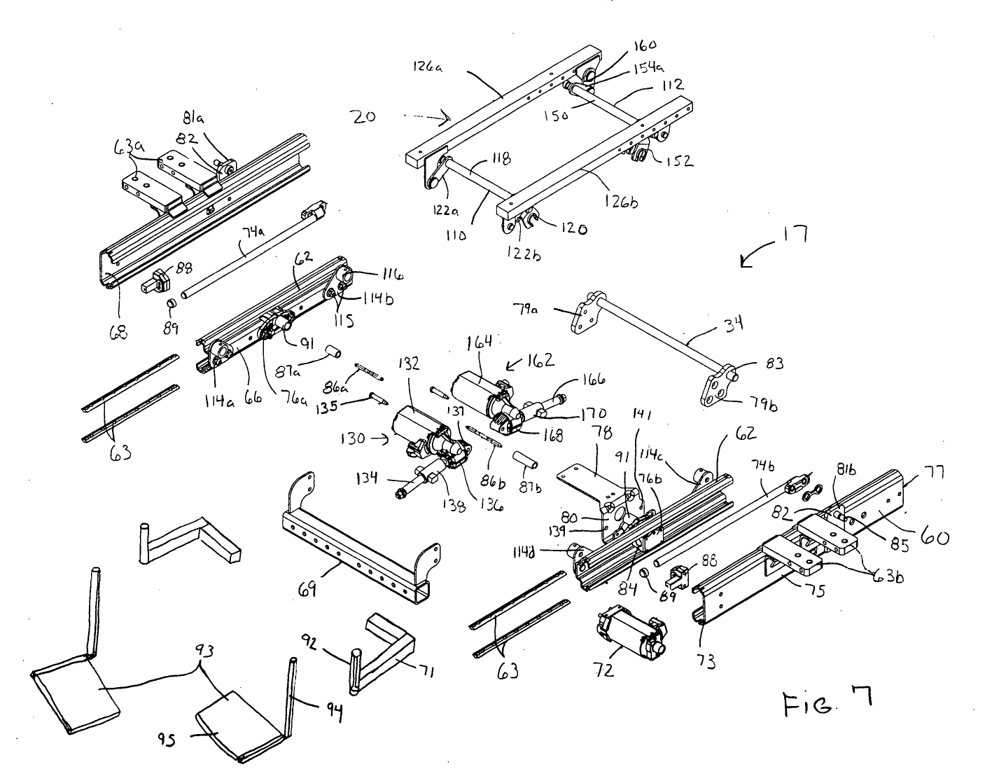

As shown in FIGS. 3-7 (FIGS. 3 and 4 also includes a tilt assembly 13), the seat depth adjustment mechanism 22 includes a pair of telescopic rails 60 and 62. The outer rails 60 are generally C-shaped in cross section, and include a front edge 73, a central portion 75, and a rear edge 77. The rails 60 may include one or more flanges 63a-b for attachment to a pair of generally standard armrest mount assemblies 65a-b. The flanges 63a-b are made from aluminum or steel, or another suitable material, and include a number of drilled holes 67 for attachment to the armrests 65 with conventional nuts and bolts. The armrest mount assemblies 65a-b are generally conventional, and may include mounting brackets 101 that attach to the flanges 63a-b, and a cross member 201 that mounts on the bracket 101 or alternatively on the flanges 63a-b. Furthermore, the armrests 65a-b may include a bottom member 203 that mounts to the bracket 101 and a top member 205 that attaches to the bottom member 203 by extending into the bottom member 203 and being fastened through holes 207 on the bottom member 203. The rails 60 may additionally include a foot rest attachment member 69 that is conventionally attached to the front 73 of the rails 60 and adapted to receive attachment from one or more foot rest brackets 71. In the illustrated embodiment, the attachment member 69 is tubular and includes vertical slots so that the foot rest brackets 71 may fit into the ends of the member 69. As shown in FIG. 7, the foot rests brackets 71 have upstanding tubular ends 92 for attachment of the foot rests 93. The foot rests 93 each include a post 94 that fits into the tubular end 92 of a bracket 71. A flat foot rest panel 95 extends from the post 94. Alternatively, a variety of other conventional foot rests can be used.

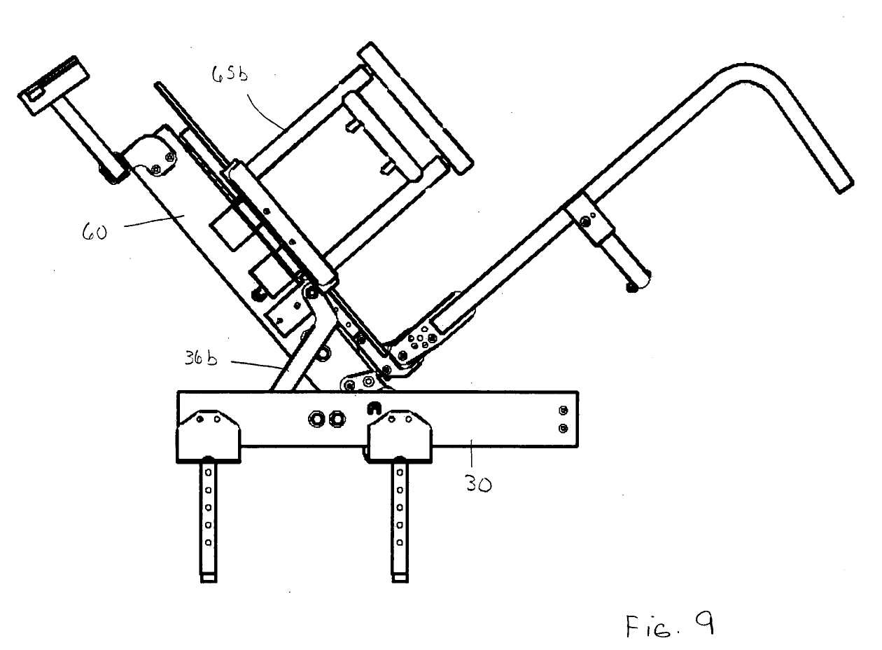

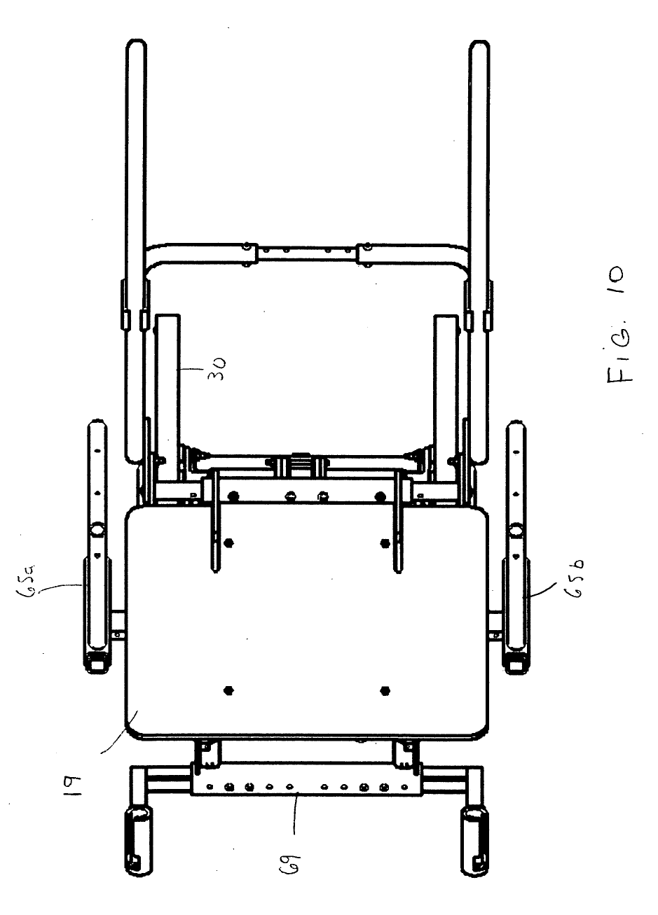

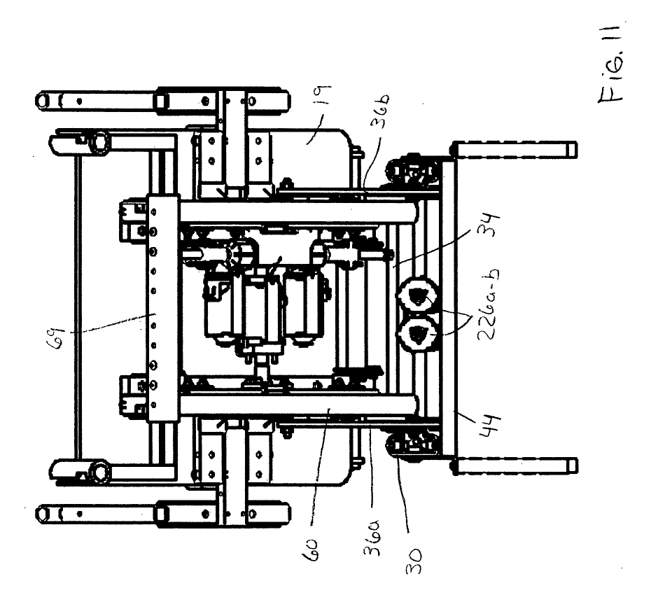

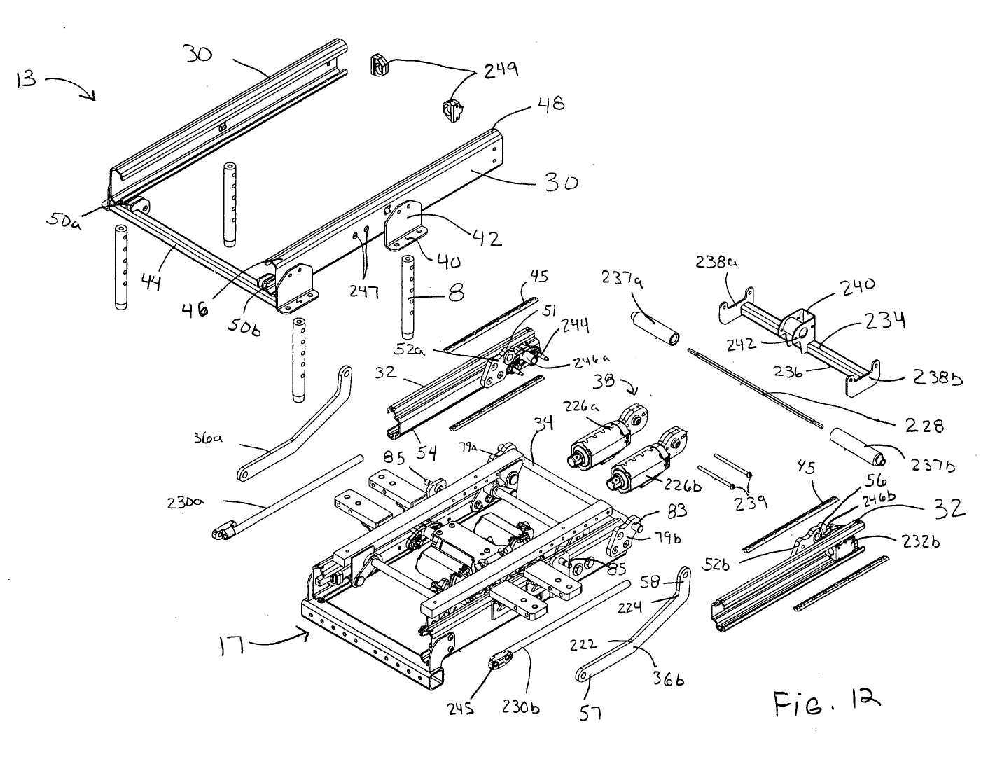

The outer rails 60 may be attached to the tilt assembly 13, which is attached to the base 12. This embodiment is shown in FIGS. 1-12. In this particular embodiment, shown in detail in FIG. 7, the outer rails 60 include pivot rod brackets 79a-b near the rear edge 77, and pivot linkage brackets 81a-b attached to the central portion 75 of the rails 60. A portion of each pivot rod bracket 79a-b preferably extends beyond the rear edge 77 of the rails 60, and defines a mounting hole 83 for receiving a pivot rod 34, discussed in further detail below. The pivot linkage brackets 81a-b preferably include a portion 82 that extends above the rails 60, and a post 85 disposed in this portion 82 and extending outward from the bracket 81. The pivot rod brackets 79a-b and the pivot linkage brackets 81a-b are preferably attached to the rails 60 with a conventional nut and bolt, but may be attached in any conventional manner.

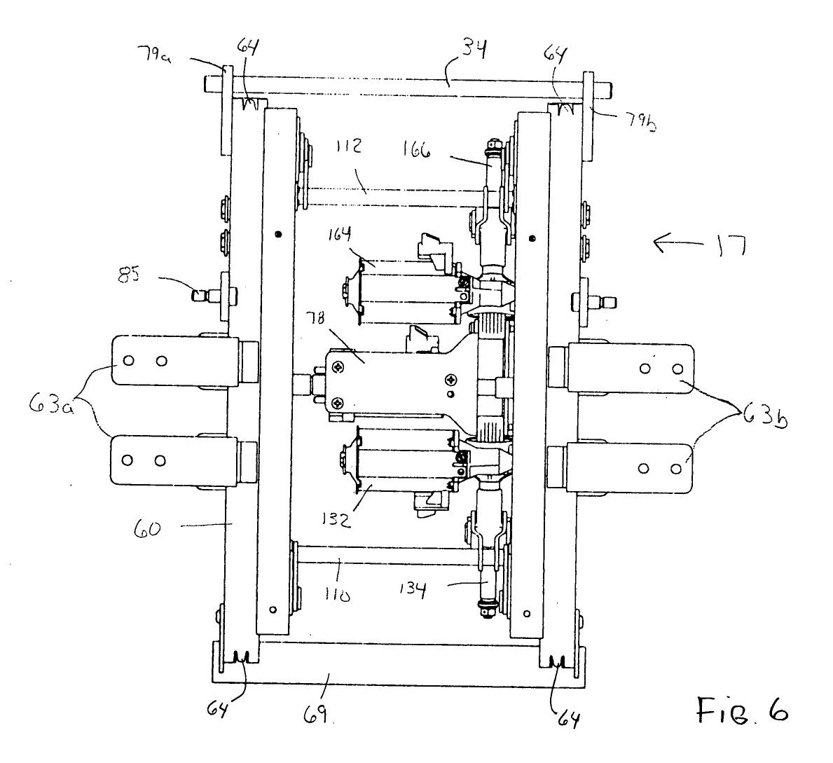

The inner rails 62 are telescopically received within the outer rails 60 and include a mounting section 66 that extends outwardly through the mouth 68 of the outer rail 60 to provide a mounting surface for the seat angle adjustment mechanism 20. The inner rail 62 and outer rail 60 are preferably roll-formed steel, but may be extruded from aluminum, aluminum alloys or other suitable materials. The various mounting holes (as shown in the drawings and described in more detail below) are drilled or punched in the rails 60 and 62 after they are formed. A pair of ball bearing cages 63, and ball bearings (not shown) are assembled between the outer rail 60 and the inner rail 62 to reduce friction and facilitate smooth, stable and easy telescopic movement of the rails (See FIG. 7). This entraps the inner rail 62 from the top and bottom. Retention tabs 64 (shown in FIG. 6) are included on both ends of the rail 60 to prevent the ball bearings from telescoping too far. As shown the tabs 64 are cut-out portions of the rails 60 that are bent inward to stop the ball bearings. Alternatively, a pair of conventional nylon, polyethylene or silicone-based guides may be secured to the interior of the outer rail 60 by double sided adhesive tape or another conventional method to reduce friction.

The seat depth adjustment mechanism 22 further includes a seat depth actuator assembly 70 that controls movement of the inner rail 62 with respect to the outer rail 60, and consequently the fore/aft position of the seat 14 with respect to the base 12. The actuator assembly 70 includes an electric motor 72, a pair of lead screws 74a-b, a pair of right angle gear boxes 76a-b and a pair of shafts or flex cables 86a-b. The gear boxes 76a-b are preferably fixedly mounted to the inner rails 62 by a nut and bolt, or other conventional mounting method, and include a receptacle 91 for receiving the shafts 86a-b. The motor 72 is fixedly mounted to a motor mounting bracket 78. The mounting bracket 78 includes a rail leg 80 that is also conventionally fixedly mounted to one of the inner rails 62. The motor 72 is attached to the bracket 78 such that shafts 86a-b extend from each side of the motor 72, and into the receptacles 91 and gear boxes 76a-b. Spacer tubes 87a-b are fitted over the shafts 86a-b to contain the shafts 86a-b. The gear boxes 76a-b extend through the mounting section 66 of the inner rails 62, and include a gear arrangement and an internally threaded lead screw hole 84 on the inside of the inner rails. The lead screws 74a-b are fixedly mounted within the mouth 68 of the outer rails. In the illustrated embodiment, one end of the lead screw 74a-b is conventionally mounted directly to the rail 60 by a nut and bolt, or other suitable method. A bushing, such as a rubber cushion, may be interposed between the lead screw 74a-b and the rail 60. The other end of the lead screw 74 is attached to the rail 60 by a lead screw stop 88. The lead screw stop 88 is fixedly attached to the rail 60 and includes a bushing 89 receiving the end of the lead screw 74a-b and fitted into the lead screw stop 88. The lead screw stop 88 prevents the gearbox 76 from traveling too far along the lead screw 88.

In the operation of the seat depth adjustment mechanism 22, rotation of the motor 72 results in axial rotation of the shafts 86a-b. The shafts 86 extend into the gear boxes 76a-b to activate the gear arrangement. This causes the lead screw hole 84 to rotate within the gearbox 76, and causes the inner rails 62 to move telescopically within the outer rails 60 along the lead screws 74a-b. In this embodiment, the armrests 65a-b and foot rests 95 remain fixed, because they are attached to the outer rails 60.

As noted above, the seat angle adjustment mechanism 20 controls the angle of the seat 15 and back support 16 with respect to the base 12. The seat angle adjustment mechanism 20 includes fore 110 and aft 112 axles that are connected to the seat supports 126a-b. The seat supports 126a-b are generally a pair of rails that extend under the seat pan 19 and are conventionally attached to the bottom of the seat pan 19. Axle mounting brackets 114a-d are mounted toward the front and rear ends of each inner rail 62. The brackets 114a-d are generally triangular in shape, and each includes a pair of bolt holes 115 and a bushing 116. The bushings 116 are configured to trap and rotatably receive the ends of the corresponding shafts 110 and 112. Each bushing 116 is preferably welded or otherwise affixed to the corresponding bracket 114a-d. A small amount of grease may be applied to the interior of each bushing 116 to reduce friction and facilitate easy rotation of the axles 110 and 112. Although the brackets 114a-d are bolted to the inner rails 62 in this embodiment, they may alternatively be welded or otherwise attached. The fore axle 110 includes a shaft 118 having a crank 120, and a pair of devises 122a-b. The fore axle 110 is preferably manufactured from conventional steel rod. The crank 120 and devises 122a-b are preferably welded in place on the axle 110. Alternatively, the fore axle 110 may be integrally cast with the crank 120 and devises 122a-b. The crank 120 is operatively interconnected with the fore tilt actuator assembly 130. More specifically, the crank 120 is adapted to pivotally receive the actuator nut 138 of the fore tilt actuator assembly 130 (described below). The devises 122a-b are located near opposite ends of the shaft 118 and are adapted to pivotally mount directly to the seat supports 126a-b.

The fore angle adjustment actuator 130 is provided to rotate the fore axle 110 and consequently control the height of the front of the seat 15 and the back support 16. The fore angle adjustment actuator 130 generally includes a motor 132, a lead screw 134, a 90 degree drive gear box 136 and an actuator nut 138—all of which are generally conventional, premanufactured components that are available from a variety of well-known suppliers. The motor 132 is attached to the motor mounting bracket 78 by a shoulder bolt 135 that extends through a mounting portion 137 on the gear box 136 and a corresponding hole 139 on the rail leg 80 of the bracket 78 so that the motor 132 can pivot about the bolt 135. In operation, rotation of motor 132 results in rotation of lead screw 134 and consequently linear movement of the actuator nut 138 along the lead screw 134. The linear movement of the actuator nut 138 is translated into rotational movement of the fore axle 110 by virtue of crank 120. The rotational movement of the axle 110 results in arcuate movement of the devises 122a-b, and consequently vertical linear movement of the front of the seat supports 126a-b and front of the seat 15.

The aft axle 112 is essentially the mirror image of the fore axle 110, having a shaft 150, a crank 152 and a pair of devises 154a-b. Unlike the fore axle 110, the devises 154a-b of the aft axle 112 are connected to the seat supports 126a-b by a linkage 160. The linkage 160 is pivotally connected between the clevis 154a-b and the corresponding seat supports 126a-b. The linkage 160 accommodates for the change in distance between the devises of the fore axle 110 and aft axle 112 that results from separate operation of the axles 110 and 112. The aft angle adjustment actuator 162 is the mirror image of the fore angle adjustment actuator 130, and includes a motor 164, a lead screw 166, a 90 degree drive gear box 168 and an actuator nut 170. The aft motor 164 is mounted to a mounting hole 141 in the motor mounting bracket 78 in the manner described above in connection with the fore angle adjustment actuator 130. Operation of the motor 164 results in rotational movement of the lead screw 166 and, in turn, linear movement of the actuator nut 170 along the lead screw 166. Linear movement of the actuator nut 170 causes rotation of the axle 112 and arcuate movement of the devises 154a-b. The arcuate movement of the devises 154a-b results in vertical movement of the rear of the seat supports 126a-b and consequently the rear of the seat 15 and back support 16. The separate fore 130 and aft 162 angle adjustment actuators permit the front and rear of the seat 15 including the back support 16 to be independently raised and lowered. As with the seat depth adjuster 22, the armrests 65a-b and the foot rests 95 do not move with the actuation of the seat angle adjuster 20 because they are attached to the fixed rails 60.

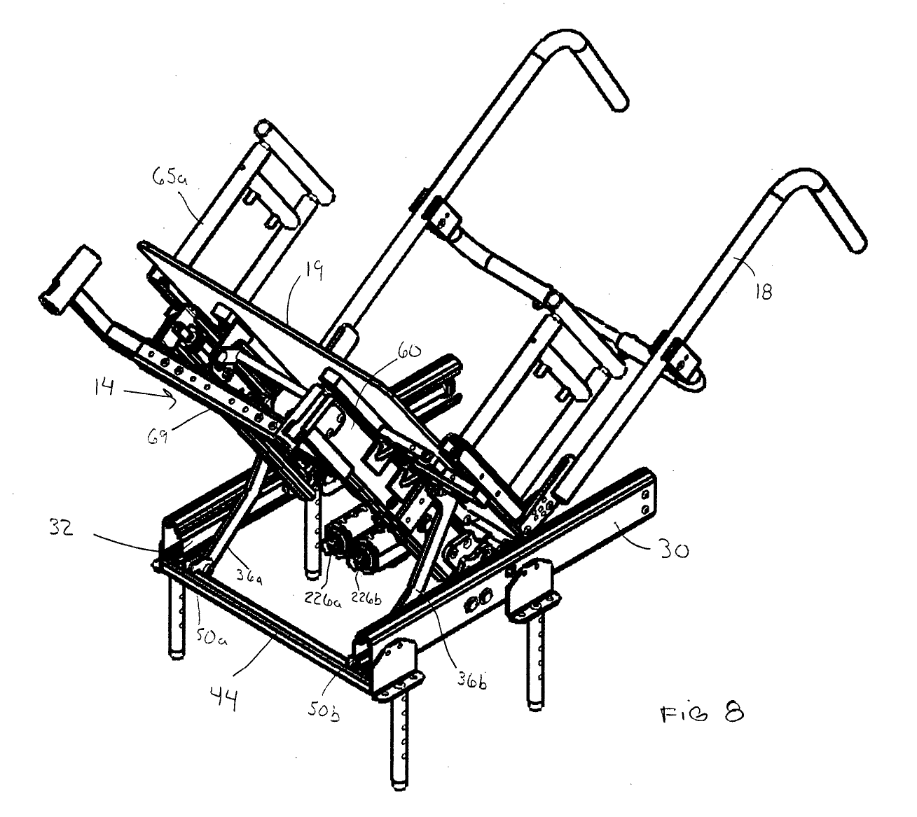

Referring now to FIGS. 8-12, the wheelchair 10 also preferably includes a tilt assembly 13. The tilt assembly 13 is interposed between the seat adjustment assembly 17 of the seat assembly 14 and the wheelchair base 12. The tilt assembly 13 generally includes right and left fixed and movable tilt rails 30 and 32, a pivot rod 34, a pair of pivot linkages 36a-b, and a tilt actuator assembly 38. In operation, (shown in FIGS. 8-11) the tilt assembly 13 can be actuated to tilt the entire seat assembly 14 relative to the base 12 without appreciably changing the center of gravity of the wheelchair.

The tilt rails 30 and 32 are generally, but not necessarily, the same as the seat adjustment rails 60, 62, and therefore will not be described again in great detail. The fixed rails 30 include a front edge 46 and a rear edge 48, and further include mounting brackets 42 for attachment to a conventional wheelchair base 12. The brackets 42 are preferably welded to the rails 30, and define additional mounting holes 40 for attachment to the base 12, or to another member, such as a post 8 that will fit into a tubular column 6 on the base 12. A cross member 44 preferably attaches between the front edges 46 of the fixed rails 30, and includes identical devises 50a-b conventionally attached to the cross member 44 adjacent to each of the respective fixed rails 30. The movable rails 32 translate telescopically within the fixed rails 30 and may include bearing cages 45 to reduce friction. The movable rails 32 include pivot rod receptacles 52a-b that are attached to the mounting section 54 of the movable rails 32, such that a portion 51 of the receptacles 52a-b defining a mounting hole 56 extends near the top of the rail 32. The mounting holes 56 are aligned with holes 83 in the pivot rod brackets 79a-b on the outer rails 60 of the seat adjustment assembly 17, so that the pivot rod 34 may extend through the holes 83 and 56 to pivotally connect the movable tilt rails 32 and the outer seat adjustment rails 60. The pivot linkages 36a-b are preferably steel or aluminum members that include a first end 57 and a second end 58, with a mounting hole at each end. As shown, the linkages 36a-b are bent at a first elbow 222 and a second elbow 224, however, the linkages may alternatively be straight. The first ends 57 of the linkages 36a-b are pivotally attached to the devises 50a-b on cross member 44, for instance, by aligning the front mounting hole within the clevis and inserting a pin (not shown) through the clevis and mounting hole. The second ends 58 are pivotally attached to the posts 85 on the seat adjustment outer rails 60, such that the posts 85 extend through the rear mounting holes.

The tilt actuation assembly 38 controls the movement of the movable rails 32 within the fixed rails 30, and includes at least one, but preferably two electric motors 226a-b, a drive shaft 228, a pair of lead screws 230a-b, and a pair of 90-degree drive gear boxes 232a-b. Alternatively, a pair of drive shafts (not shown) may be used on conjunction with a coupler. The motors 226a-b are preferably aligned parallel to each other, so that the drive shaft 228 can pass through both motors with both motors 226a-b acting together to rotate the drive shaft 228. The motors 226a-b are preferably mounted to the movable tilt rails 32 by a motor support 234. The motor support 234 includes a rod 236 that extends between the rails 32 and conventionally attaches to the rails 32 with brackets 238a-b on opposing ends and corresponding posts 244 extending from the movable rails 32. The motor support 234 further includes a U-shaped bracket 240 having an opening 242 extending through the U-shaped bracket for passage of the drive shaft 228, and mounting holes on either side of the opening for bolts 239 that pass through both motors and the holes to support the motors in an aligned position. A pair of tubes 237a-b slide over the ends of the drive shaft 228 to contain the drive shaft 228. The gear boxes 232a-b are mounted to the mounting section 54 of the rails 32, and include a pair of receptacles 246a-b on one side of the mounting section and a pair of gear arrangements on the other side similar to the gear boxes 76a-b of the seat depth adjuster 70. One end of the lead screws 230a-b is mounted to the inside of the fixed rails 30, for instance, by bolts that extend through mounting holes 245 on the lead screw 230 and corresponding holes 247 on the rails 30. The other end may be supported by a locator block 249 mounted inside the rear edge 48 of the rails 30.

In operation, as the drive shaft 228 rotates, the gear boxes 232 travel simultaneously along lead screws 230a-b, causing linear movement of the gear boxes 232 along lead screws 230a-b, and consequently telescopic movement of the movable rails 32 inside the fixed rails 30. As the rails 32 translate forward, the seat assembly 14 is pushed forward by the attachment of the movable rails 32 to the outer rails 60 with the pivot rod 34. As the seat assembly 14 is pushed forward, the front end 57 of the pivot linkages 36a-b remains fixed to the cross member 44 of the fixed rails 30. As a result, the rear end 58 of the pivot linkages 36a-b is forced upward, consequently forcing the front end of the seat assembly 14 upward by the attachment at the posts 85, as the back of the seat assembly pivots about the pivot rod 34. A spring or other assist mechanism (not shown) may be used to aid in the initial tilt of the seat. Since the armrests 65a-b and foot rest brackets 71, including foot rests 95, are attached to the fixed rails 60 of the seat assembly 14, they tilt with the seat assembly 14.

Referring again to FIGS. 1 and 2, all of the actuators can be operated by conventional electronic controls 200 on a control bracket 220. As shown, the controls 200 are mounted on one armrest 65, however, they may be mounted in any position suitable for the user. In one embodiment, the controls 200 include two switches 202 and 204 for controlling the seat adjustment and tilt operations. The first switch 202 is positioned vertically to represent the seat back, and the second switch 204 is positioned horizontally to represent the seat surface. In this embodiment, the first switch 202 may be moved forward and backwards to actuate the tilt mechanism, and the second switch may be pivoted up and down in both the front and back to control the seat angle and translated forward and backward to control the seat depth. The movement of the wheelchair base 12 may be controlled by a second set of controls 250. In this embodiment, the controls 250 include a joystick 260 for controlling the direction of the movement of the base 12. The described controls 200, 250 are available from a well-known suppliers, and can be replaced by other conventional controls such as independent switches, voice command controls, shoulder and head operated controls and any other conventional type of controls as desired depending on the occupant's capabilities. The various motors (not shown) are powered by a rechargeable battery and are generally mounted within the base 12. In one embodiment, the various motors operate on 24 volts dc and the battery is a conventional 24 volt battery, such as the type conventionally used with cordless power tools. Alternatively, there maybe separate batteries for each actuator, and/or 12 volt motors may be used with a stepped down voltage. Conventional wiring 214 is run between the battery, the controls 200, 250 and the various actuator motors.

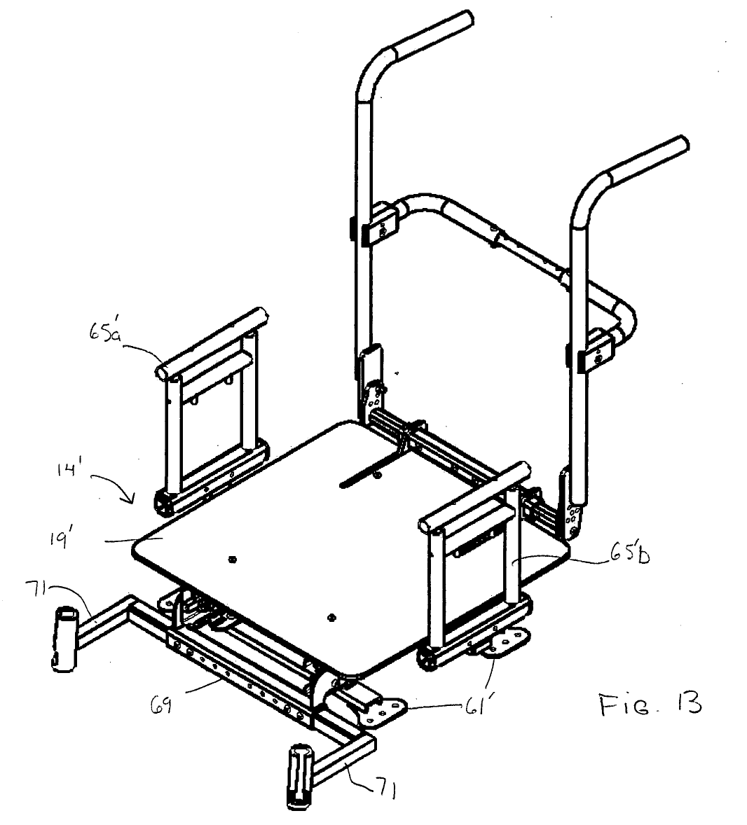

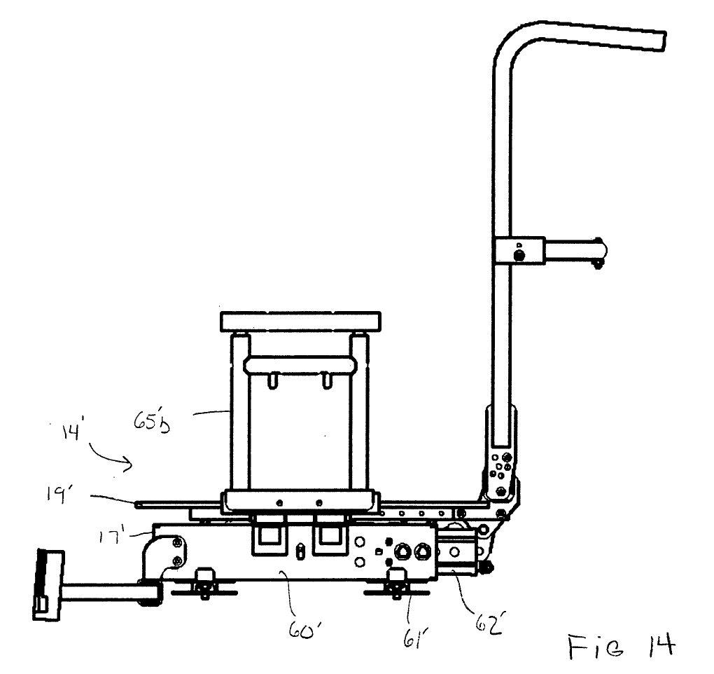

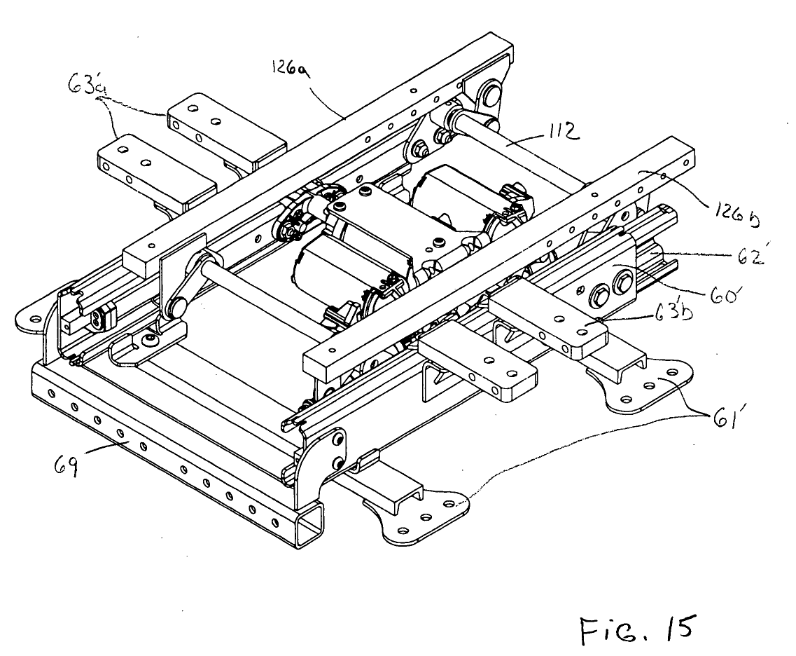

FIGS. 13-15 show another embodiment of the wheelchair with the tilt assembly 13 not included. In this embodiment, the seat assembly 14′ is attached directly to the wheelchair base 12 (not shown). The rails 60′ are provided with one or more mounting brackets 61′ that conventionally attach directly to the base 12, or to the posts 8 described in connection with the first embodiment. As shown, the mounting brackets 61′ attach to brackets (not shown) on the bottom of the rails 60′, for example, by a conventional nut and bolt or another suitable attachment method. The mounting brackets 61′ are essentially the same as the brackets 42 described above for attaching the tilt assembly 13 to the base 12, and therefore attach the seat assembly 14′ to the base in a substantially similar manner to provide for the repositioning of the seat 15 and back support 16 relative to the base 12. The remaining structure of the seat assembly 14′ and seat adjustment assembly 17′ is essentially the same, except that the pivot mounting brackets 81a-b and the pivot mounting brackets 79a-b and pivot rod 34 are unnecessary and not included. The seat depth adjuster 22′ and the seat angle adjuster 20′ operate in the same manner as described above, so that the seat assembly can be actuated forward and backward and can be tilted up or down in the front or back. Since the armrests 65′ and foot rest brackets 71′ are attached to the fixed rails, they remain fixed as the seat assembly 14′ is actuated. Of course, they may be attached to the moveable rails to move along with the seat assembly 14′.

The above description is that of the current embodiments of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

1. A power adjustable wheelchair comprising:
a wheelchair base including a plurality of wheels;
a seat;
an adjustment assembly providing adjustment of said seat relative to said base, said adjustment assembly including a mounting portion connected to said base, and a seat support attached to said seat, said seat support being movable with respect to said mounting portion whereby the seat assembly is movable horizontally with respect to said base, and vertically with respect to said base at a first location and a second location;
a plurality of adjustment actuators mounted to said adjustment assembly, said actuators operable to provide said movement of said seat with respect to said base, said actuators including at least one battery powered motor.

2. The wheelchair of claim 1 further including a pair of armrests located on opposing sides of said seat, and a foot rest, said armrests and said foot rest attached to said base or said mounting portion of said adjustment assembly whereby said seat is movable independent of said armrests and said foot rest.

3. The wheelchair of claim 2 further comprising a tilt assembly, said tilt assembly including a fixed portion that is fixedly connected to said base, and a movable portion connecting said fixed portion to said mounting portion of said adjustment assembly whereby said adjustment assembly and said seat tilt together relative to said base.

4. The wheelchair of claim 3, wherein said fixed portion of said tilt assembly includes right and left fixed rails that are linked at a front end by a cross member.

5. The wheelchair of claim 4, wherein said movable portion of said tilt assembly includes:
right and left movable rails, said movable rails translating telescopically within said fixed rails and having a rear portion and a front portion,
a pivot rod, said pivot rod fixedly attached to the rear of said seat, and pivotally attached to a rear portion of said movable rails, and
a pivot linkage, said pivot linkage pivotally attached at a first end to a central portion of said adjustment assembly, and at a second end to said cross member of said fixed portion of said tilt assembly, whereby as said movable rails are translated, said pivot rod pushes said adjustment assembly forward so that said pivot linkage pivots about said fixed second end forcing said first end of said pivot linkage and said central portion of said adjustment assembly to raise vertically with respect to said fixed portion.

6. The wheelchair of claim 5 wherein said adjustment assembly includes right and left adjustment rail assemblies, said rail assemblies each including telescopic fixed and movable rails, said fixed rails having a rear portion attached to said pivot rod, a central portion attached to said first end of said pivot linkage, and a front portion, said movable adjustment rails connected to said seat support and movable within said fixed rails by an actuator including a battery-powered motor, whereby movement of said movable adjustment rails results in movement of said seat.

7. The wheelchair of claim 6, wherein said adjustment assembly further comprises first and second axles mounted between said movable rails of said left and right adjustment rail assemblies, said axles each including a crank and a clevis, said clevis pivotally connected to said seat support; and
first and second angle adjustment actuators, each including a battery-powered motor, and each pivotally attached to one of said clevises, said angle adjustment actuators being operable to rotate said first and second axles respectively, whereby rotation of said first axle results in movement of one said devises and consequently vertical movement of the front portion of the seat, and whereby rotation of said second axle results in rotation of the other clevis and consequently vertical movement of the rear portion of the seat.

8. The wheelchair of claim 7 wherein said fixed tilt assembly rails include a plurality of posts for attachment to a standard wheelchair base.

9. The wheelchair of claim 8, wherein said right and left fixed adjustment assembly rails each include at least one flange for attachment of one of said armrests.

10. The wheelchair of claim 9, wherein said front portion of said right and left fixed adjustment assembly rails are connected by a foot rest attachment member, said foot rest attachment member adapted to receive attachment from said foot rest.

11. A power adjustable wheelchair comprising:
a wheelchair base including a plurality of wheels, said wheels operable by a battery-powered motor;
a power adjustable seat assembly including a seat and an adjustment assembly, said adjustment assembly providing said seat assembly with horizontal movement, said adjustment assembly further providing vertical movement of at least one of a front and a rear portion of said seat assembly, said seat assembly movements operable by a battery-operated motor; and
a power tilt assembly connecting said seat assembly to said base, said tilt assembly including battery powered actuators for tilting said seat assembly with respect to said base.

12. The wheelchair of claim 11, further including an armrest and a foot rest, said armrest and said foot rest attached to said seat adjustment assembly, whereby said armrest and said foot rest are stationary when said seat adjustment assembly are actuated, but are tilted when said tilt assembly is actuated.

13. The wheelchair of claim 12, wherein said tilt assembly includes a fixed portion and a movable portion, said fixed portion adapted to attach to said wheelchair base.

14. The wheelchair of claim 13, wherein said fixed portion of said tilt assembly includes right and left fixed rails that are linked at a front end by a cross member.

15. The wheelchair of claim 14, wherein said movable portion of said tilt assembly includes right and left movable rails, a pivot rod, and a pivot linkage, said movable rails translating telescopically by a battery powered actuator within said fixed rails and having a rear portion that is pivotally attached to said pivot rod, said pivot rod fixedly attached to said adjustment assembly at a rear portion of said adjustment assembly, said pivot linkage pivotally attached at a first end to said adjustment assembly, and at a second end to said fixed portion, whereby as said movable rails are translated, said pivot rod and said adjustment assembly are pushed forward and said adjustment assembly tilts about said linkage and said pivot rod.

16. The wheel chair of claim 15 wherein said adjustment assembly includes right and left adjustment rail assemblies, said adjustment rail assemblies each including telescopic fixed and movable adjustment rails, said fixed adjustment rails having a rear portion attached to said pivot rod, a central portion attached to said first end of said pivot linkage, and a front portion, said movable adjustment rails connected to said seat support and movable within said fixed rails by an actuator including a battery-power motor, whereby movement of said movable adjustment rails results in movement of said seat assembly.

17. The wheelchair of claim 16 wherein said adjustment assembly further comprises first and second axles mounted between said movable rails of said left and right adjustment rail assemblies, said axles each including a crank and a clevis, said clevis pivotally connected to said seat support; and
first and second angle adjustment actuators, each including a battery-powered motor, and each pivotally attached to one of said clevises, said angle adjustment actuators being operable to rotate said first and second axles respectively, whereby rotation of said first axle results in movement of one said devises and consequently vertical movement of the front portion of the seat, and whereby rotation of said second axle results in rotation of the other clevis and consequently vertical movement of the rear portion of the seat.

18. The wheelchair of claim 17 wherein said fixed tilt assembly rails include a plurality of posts or brackets for attachment to a standard wheelchair base.

19. The wheelchair of claim 18, wherein said right and left fixed adjustment assembly rails each include at least one flange for attachment of one of said armrests.

20. The wheelchair of claim 19, wherein said front portion of said right and left fixed adjustment assembly rails are connected by a foot rest attachment member, said foot rest attachment member adapted to receive attachment from said foot rest.

21. A power adjustable wheelchair comprising:
a wheelchair base including at least two wheels;
a seat assembly including a seat, said seat including a front portion, a central portion, and a rear portion;
a tilt assembly for tilting said seat assembly relative to said base, said tilt assembly comprising:
right and left fixed rails attached to said base;
right and left movable rails, said movable rails translating telescopically within said fixed rails, said translation operable by an actuator including at least one battery-powered motor;
a pivot rod that is pivotally attached to said movable rails and fixedly attached to said seat assembly; and
a pivot linkage having a first end and a second end, said first end pivotally attached to said seat assembly, said second end pivotally attached to said fixed rails whereby as said movable rails are translated within said fixed rails, said pivot rod drives pushes said seat assembly, forcing said pivot linkage to pivot about said second end so that said first end of said pivot linkage and said seat assembly raise vertically with respect to said wheelchair base.

22. The wheelchair of claim 21 wherein said seat assembly further includes a pair of armrests on opposing sides of said seat, a back support, and a foot rest.

23. The wheelchair of claim 22, said seat assembly further including an adjustment assembly, said adjustment assembly providing said seat and said back support with horizontal movement, and further providing vertical movement of at least one of said front portion, said central portion, and said rear portion of said seat assembly, said seat assembly movements operable by a battery-operated motor.

24. The wheelchair of claim 23 wherein said at least one tilt assembly motor is attached between said tilt assembly movable rails.

25. The wheelchair of claim 24 wherein said adjustment assembly includes right and left adjustment rail assemblies, said adjustment rail assemblies each including telescopic fixed and movable adjustment rails, said fixed adjustment rails having a first portion attached to said pivot rod, a second portion attached to said first end of said pivot linkage, said movable adjustment rails connected to said seat and movable within said fixed rails by an actuator including a battery-powered motor, whereby movement of said movable adjustment rails results in movement of said seat.

26. The wheelchair of claim 25 wherein said adjustment assembly further comprises first and second axles mounted between said movable rails of said left and right adjustment rail assemblies, said axles each including a crank and a clevis, said clevis pivotally connected to said seat; and
first and second angle adjustment actuators, each including a battery-powered motor, and each pivotally attached to one of said clevises, said angle adjustment actuators being operable to rotate said first and second axles respectively, whereby rotation of said first axle results in movement of one said devises and consequently vertical movement of the front portion of the seat, and whereby rotation of said second axle results in rotation of the other clevis and consequently vertical movement of the rear portion of the seat.

27. The wheelchair of claim 26 wherein said fixed tilt assembly rails include a plurality of posts or brackets for attachment to a standard wheelchair base.

28. The wheelchair of claim 27 wherein said right and left fixed adjustment assembly rails each include at least one flange for attachment of said armrests.

29. The wheelchair of claim 28 wherein said front portion of said right and left fixed adjustment assembly rails are connected by a foot rest attachment member, said foot rest attachment member adapted to receive attachment from said foot rest.

30. A power actuated wheelchair comprising:
a base;
a seat assembly including a seat and a back;
an adjuster interconnecting said seat assembly and said base, said adjuster including a seat angle adjuster for adjusting a height of a front of said seat and a height of a back of said seat, and a seat depth adjuster for adjusting a depth of said seat with respect to said base.

31. The power actuated wheelchair of claim 30 wherein said seat angle adjuster includes a front height adjuster for adjusting said height of said front of said seat and a rear height adjuster for adjusting said height of said rear of said seat relative to said base.

32. The power actuated wheelchair of claim 31 wherein said seat and said back are interconnected whereby said back moves with said seat.

33. The power actuated wheelchair of claim 32 further including an armrest that does not move with said seat angle adjuster or said seat depth adjuster.

34. The power actuated wheelchair of claim 33 further including a footrest that does not move with said seat angle adjuster and said seat depth adjuster.

35. The power actuated wheelchair of claim 34 further including a tilt adjuster for tilting said seat assembly and said armrest and said footrest relative to said base.

36. The power actuated wheelchair of claim 30 further including an armrest and a foot rest that move together with the seat angle adjuster and the seat depth adjuster.
